(19) United States
(12) Patent Application Publication
(10) Pub. No.: US 2022/0313014 A1
(43) Pub. Date: Oct. 6, 2022

(54) Apparatus and Method For A Mobile Water-Based Cooking System

(71) Applicant: Remarkable Foods, Inc., Clark, NJ (US)

(72) Inventors: William Bartz, Kansas City, MO (US); Alphonse A. Lanza, River Edge, NJ (US); George Meyerle, Brookfield, CT (US); Sean Christopher Wyatt, Chicago, IL (US)

(21) Appl. No.: 17/216,954

(22) Filed: Mar. 30, 2021

(51) Int. Cl. A47J 36/32; G05B 15/02; B60K 35/00; A47J 36/06; A47J 27/18; A47J 27/12

(52) U.S. Cl. CPC A47J 36/321; G05B 15/02; B60K 35/00; A47J 36/06; A47J 27/18; A47J 27/12; B60K 2370/148; B60K 2370/161; A47J 2202/00; A47J 2203/00

(57) ABSTRACT

A water-based cooking apparatus onboard a vehicle includes a cooking bay and a controller. The cooking bay can be sealed with a lid so that water does not escape the cooking bay when the vehicle is in motion. The controller receives, from a computing device onboard the vehicle, cooking instructions including commands operable to perform one or more of filling the cooking bay with water, setting a temperature for the cooking bay, and adjusting a salinity of water in the cooking bay. The computing device can display cooking instructions on a display and can send status reports to a remote command center.

### TECHNICAL FIELD

Embodiments of the technology relate generally to a cooking system for food preparation in a vehicle.

### BACKGROUND

Cooking apparatus referred to as rethermalizers are used in restaurants for heating food. Conventional rethermalizers include a cooking bay that contains water and a heating element that heats the water to a desired temperature. Food that is sealed in a plastic bag is placed in the heated water. Once the food is finished cooking or warming, the plastic bag containing the food is removed from the cooking bay of the rethermalizer and the food is removed from the plastic bag for serving. Such a cooking apparatus can also cook pasta and other foods in the heated water of the cooking bay.

Conventional rethermalizers are not designed to be installed and used in a vehicle in which food is to be prepared. The movement of the vehicle may cause the water and/or the food to spill out of the rethermalizer. Additionally, conventional rethermalizers are not designed to assist the chef with cooking multiple types of food simultaneously or in parallel in the rethermalizer. For example, conventional rethermalizers do not provide intuitive indicators and controls that assist the chef when cooking multiple types of food simultaneously.

Therefore, in light of the challenges and limitations presented with the operation of a conventional rethermalizer, an improved rethermalizer that addresses one or more of these challenges would be beneficial.

### SUMMARY

The present disclosure is generally directed to an improved water-based cooking system suitable for use in a vehicle. In one example embodiment, the present disclosure is directed to a cooking apparatus configured for installation in a vehicle wherein the cooking apparatus comprises a housing, a cooking bay, and a controller that controls the operation of the cooking bay. The cooking bay can comprise a heating element, a sensor, an inlet port, a drain port, and a lid that covers the cooking bay. An inlet pipe comprising an inlet valve can supply water to the cooking bay. A drain pipe comprising a drain valve can evacuate water from the cooking bay.

In the foregoing example embodiment, the cooking apparatus can further comprise a latch for securing the lid to the cooking bay and a gasket that creates a seal between the lid and the cooking bay. The cooking bay can further have an associated indicator light, the indicator light indicating one of a plurality of states, including a ready state and a not ready state. In the foregoing example embodiment, the inlet pipe can be coupled to a pressurized water tank supplying the water to the cooking bay and the cooking apparatus and pressurized water tank can be located onboard a vehicle.

In the foregoing example embodiment, the controller can be in communication with a computing device that is also onboard the vehicle. The computing device can comprise instructions operable to direct the controller to activate the inlet valve and the drain valve. The computing device can further comprise instructions that direct the controller to activate the heating element. Additionally, the computing device can comprise an input device that comprises one of a foot pedal and a microphone.

In the foregoing example embodiment, the computing device can further comprise instructions for determining a first preparation schedule for a first food item and a second preparation schedule for a second food item, wherein the first preparation schedule comprises a first plurality of cooking instructions and wherein the second preparation schedule comprises a second plurality of cooking instructions. Furthermore, the first preparation schedule can set preparation of the first food item to be completed within a first threshold time of arriving at a first destination and the second preparation schedule can set preparation of the second food item to be completed within a second threshold time of arriving at a second destination.

In another example embodiment, the present disclosure is directed to a method for operating a cooking apparatus. The example method can comprise a series of manual operations performed by a chef coupled with automated control functions occurring between the cooking apparatus and a computing device. The example method can comprise analyzing, by a computing device, first preparation instructions associated with a first food item. The analysis of the first preparation instructions can result in a series of cooking instructions wherein the computing device displays a first cooking instruction to set a temperature for a cooking bay of the cooking apparatus. The computing device can receive a confirmation that the first cooking instruction has been completed so that the computing device can track the progress of the cooking instructions. Next, in response to an indication that the vehicle has arrived at a destination, the computing device can display a second cooking instruction to place the first food item into the cooking bay. After receiving a confirmation that the first food item has been placed in the cooking bay, the computing device can set a first timer associated with the first preparation instructions. Once the first timer lapses, the computing device can display a third cooking instruction to remove the first food item from the bay and, in response thereto, the computing device can receive a confirmation that the first food item has been removed from the cooking bay.

In the foregoing example method, the computing device can receive confirmations that a cooking instruction has been completed via an input device such as a foot pedal or a microphone that enable the chef to avoid manual contact with the computing device. The computing device can also initiate commands to a controller of the cooking apparatus to turn on and off indicator lights associated with the cooking bay to assist the chef by indicating the status of the cooking bay or the food in the cooking bay. The computing device can also send status reports to a remote command center monitoring the operations of the vehicle. The status reports can indicate when food items are being prepared and when the preparation is complete and the food item is ready for delivery to a customer.

In another example embodiment, the present disclosure is directed to another method for operating a cooking apparatus that is more automated than the previously described method by relying on further communication between the cooking apparatus and the onboard computing device. The example method can comprise determining, by a computing device, a first preparation schedule associated with a first food item and a second preparation schedule associated with a second food item. Further automating the cooking instructions and the communications between the cooking apparatus and the onboard computing device facilitates managing multiple preparation schedules for different food items that may occur in series, in parallel, or in a staggered parallel approach. The example method can proceed with the first preparation schedule wherein the computing device provides a first cooking instruction to the cooking apparatus to set a temperature for a first cooking bay. In response to the vehicle arriving at a first destination, the computing device can display a second cooking instruction to place the first food item into the first cooking bay and the computing device can set a first timer associated with the first preparation schedule. Lastly, the computing device can display a third cooking instruction to remove the first food item from the first cooking bay.

In the foregoing example method, the computing device can begin the second preparation schedule so that the second food item will be promptly prepared upon arrival at a second destination. The computing device can begin the second preparation schedule at a point during the first preparation schedule so that the two food items are prepared in parallel or overlapping schedules. Alternatively, the computing device can begin the second preparation schedule in series following the first preparation schedule. The computing device begins by providing a fourth cooking instruction to the cooking apparatus to set a temperature for a second cooking bay. In response to the vehicle arriving at the second destination, the computing device can display a fifth cooking instruction to place the second food item into the second cooking bay and the computing device can set a second timer associated with the second preparation schedule. Lastly, the computing device can display a sixth cooking instruction to remove the second food item from the second cooking bay.

In the foregoing example, the first preparation schedule can be based on a first estimated arrival time at the first destination, an average performance of the cooking apparatus, and a heat capacity of the first food item and the second preparation schedule can be based on a second estimated arrival time at the second destination, an average performance of the cooking apparatus, and a heat capacity of the second food item. The computing device can further be operable to adjust the first preparation schedule based on an estimated arrival time for the first destination and adjust the second preparation schedule based on an estimated arrival time for the second destination. In the foregoing example method, in response to receiving a sensor signal, the computing device can provide to the cooking apparatus a command to adjust one or more of a salinity of water in the first cooking bay, a level of the water in the first cooking bay, and a temperature of the water in the first cooking bay.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a water-based cooking system and therefore are not to be considered limiting of the scope of this disclosure. The principles illustrated in the example embodiments of the drawings can be applied to alternate methods and apparatus for a water-based cooking system. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 is a perspective view of a water-based cooking system in accordance with the example embodiments of the disclosure.

FIG. 2 is another perspective view of a portion of the water-based cooking system of FIG. 1 in accordance with the example embodiments of the disclosure.

FIG. 3 is a side cross-sectional view of the water-based cooking system of FIG. 1 in accordance with the example embodiments of the disclosure.

FIG. 4 is a block diagram illustrating the architecture of the water-based cooking system and a computing device onboard a vehicle in accordance with the example embodiments of the disclosure.

FIG. 5 is a flow chart of an example method of operating a water-based cooking system in accordance with the example embodiments of the disclosure.

FIG. 6 is a flow chart of an example method of operating a water-based cooking system in accordance with the example embodiments of the disclosure.

FIG. 7 is flow chart of an example method of operating a water-based cooking system in accordance with the example embodiments of the disclosure.

### DETAILED DESCRIPTION OF EXAMPLE EMBODIMENTS

The example embodiments discussed herein are directed to apparatus and methods for a water-based cooking system. The example embodiments described herein can provide an advantageous cooking system that can be used in vehicles in which food is prepared. Specifically, the example embodiments described herein provide a water-based cooking apparatus, such as a rethermalizer or pasta cooker, that communicates with an onboard computing device to manage the timely preparation of food items. The computing device can provide instructions to the chef and the one or more controllers of the cooking apparatus in accordance with a preparation schedule to expedite the preparation of food items as well as to time the preparation of the food items to optimize the condition of the food items upon delivery to the customer. The communications between the computing device and the cooking apparatus allow for coordinating the preparation of multiple food items in parallel, in a staggered manner, or in series. Additionally, the computing device can receive sensor signals concerning the operation of the cooking apparatus and provide commands to the cooking apparatus controller to optimize its performance. Lastly, the cooking apparatus is designed so that water and food will not spill from the cooking apparatus when the vehicle is in motion.

As will be described further in the following examples, the methods and apparatus described herein improve upon prior approaches to cooking food in vehicles. Precise management of the preparation schedules for the food items results in more efficient energy use while cooking. Coordination between the computing device and the cooking apparatus also minimizes cooking errors that result in wasting of food. The techniques described herein eliminate undesirable components and conditions when compared to prior art approaches.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

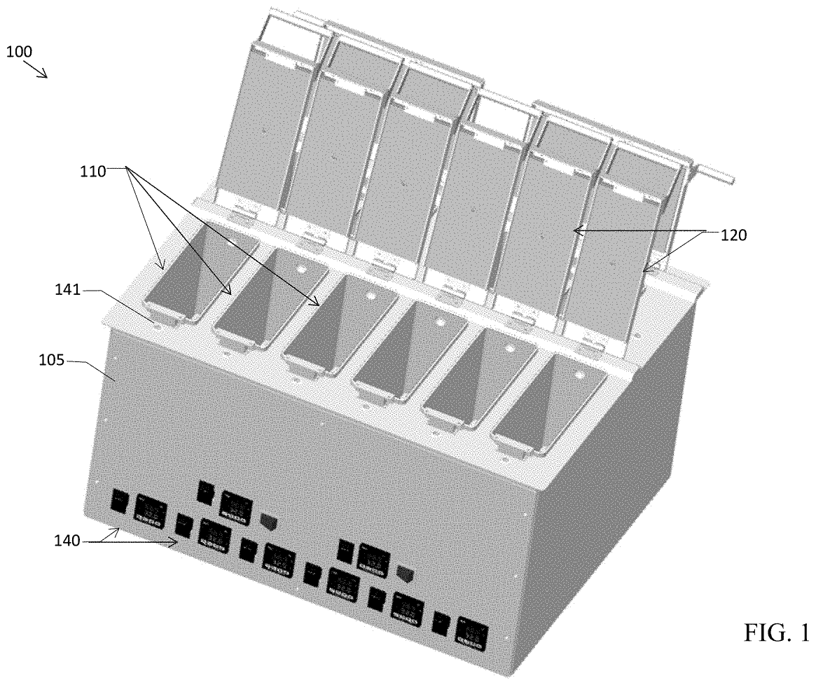

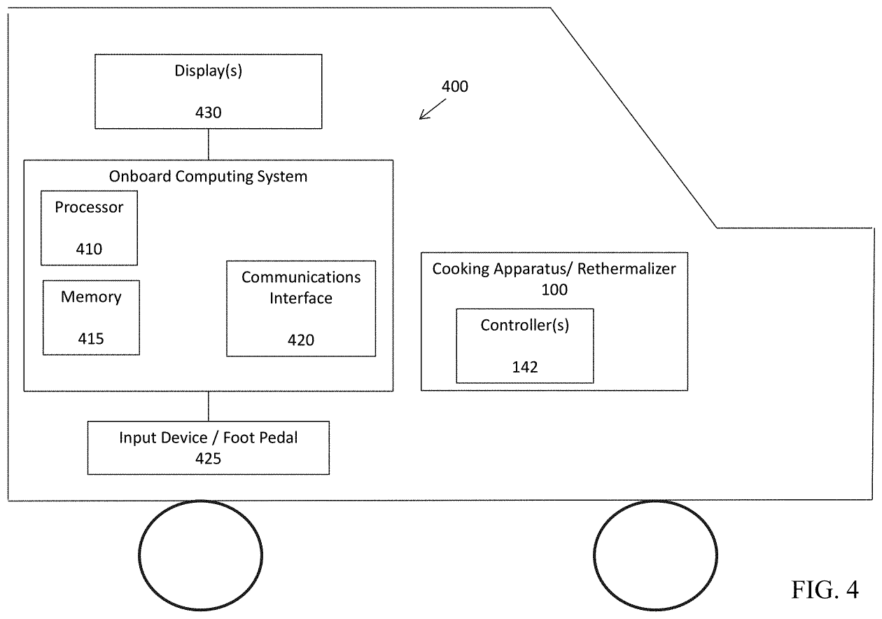

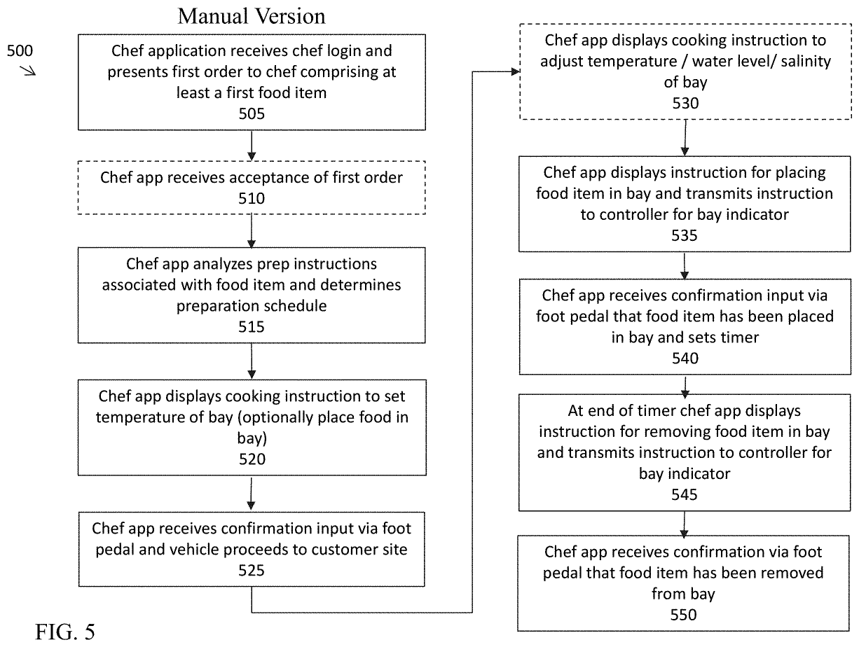

FIGS. 1-3 illustrate aspects of an example water-based cooking apparatus. FIG. 4 illustrates the cooking apparatus and the onboard computing device mounted in an example vehicle. FIG. 5-7 illustrate example methods of operating the cooking apparatus and the onboard computing device.

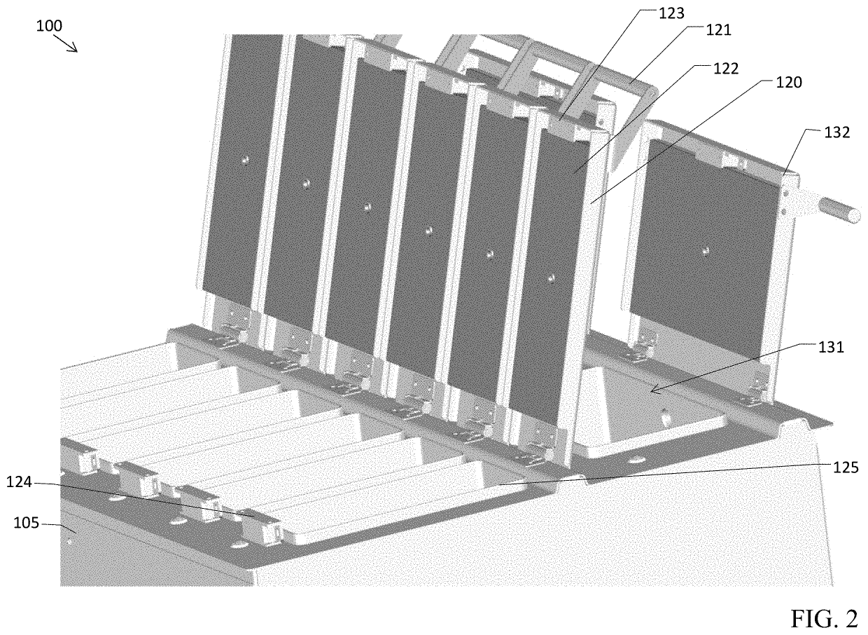

Referring now to FIGS. 1 and 2, top perspective views of the exterior of the cooking apparatus are illustrated in accordance with the example embodiments of the present disclosure. The cooking apparatus 100 comprises a housing 105 with a top panel in which cooking bays 110 and 131 are positioned. In the example cooking apparatus 100, six smaller cooking bays 110 are located toward the front of the top panel of the housing 105 and two larger cooking bays 131 are located toward the back of the top panel. In one example embodiment, the smaller cooking bays 110 can be used as rethermalizers for reheating food, whereas the two larger cooking bays 131 can be used for cooking pasta or similar food items. It should be understood that the number, shapes, positions, and use of the cooking bays can be varied in alternative embodiments.

Each cooking bay 110, 131 can have a lid 120, 132 that is attached to the cooking apparatus with a hinge. The lids 120, 132 generally can be kept in a closed position and can be opened using handle 121, for example, when a chef is placing food in or removing food from the cooking bay 110, 131. Each lid 120, 132 can include flexible gasket material 122 on the underside of the lid that engages a rim 125 of the cooking bay 110, 131 when the lid is closed. The flexible gasket material 122 can be silicone, rubber, or another similar material that maintains a seal with the rim 125 of the cooking bay 110, 131 when the lid is closed. Each lid 120, 132 can also include a latch that secures the lid when it is in the closed position. The latch can comprise a first coupler 123 located on the underside of the lid 120, 132 and a second coupler 124 located on the top panel of the housing 105. The first coupler 123 and second coupler 124 can fasten to each other when joined in order to secure the lid in a closed position. The first coupler 123 and second coupler 124 can be fastened together using any known mechanical coupling mechanism including but not limited to detents, tabs, snaps, and magnets. Securing the lid 120, 132 to the rim 125 of the cooking bay can be valuable in preventing water and food from splashing out of the cooking bay when the vehicle is in motion.

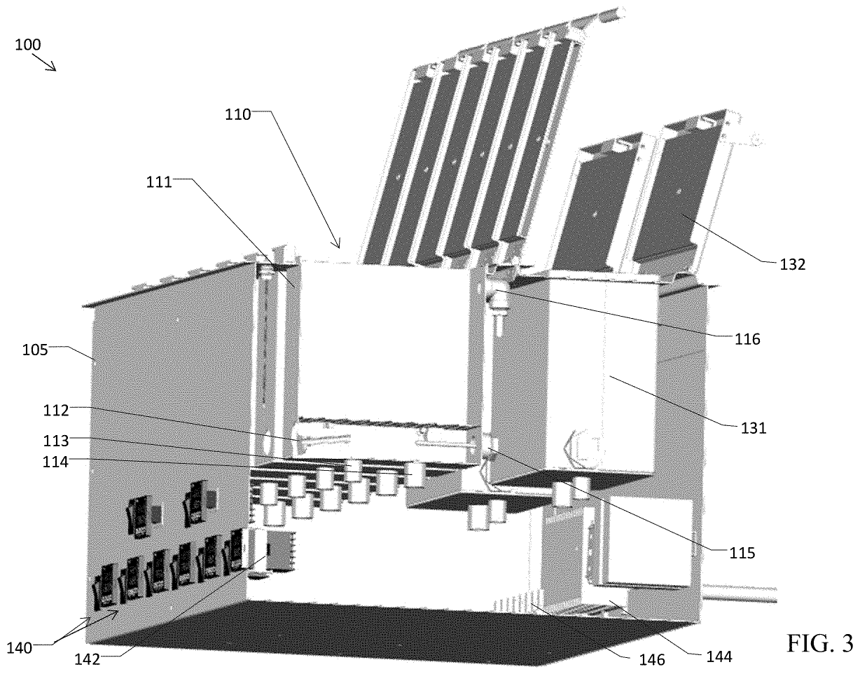

Referring to FIG. 3, a cross-sectional side view of the example cooking apparatus 100 of FIGS. 1 and 2 is provided which shows interior components of the cooking apparatus. As can be seen in FIG. 3, each cooking bay 110 comprises several components. Specifically, each cooking bay 110 can comprise an inlet port 113 and a drain port 114 for filling and removing water from the cooking bay 110. The cooking bay can also include an overflow port 116 to remove water from the cooking bay 110 if the water level is too high. The inlet port 113 can be connected to an inlet pipe. Similarly, the drain port 114 and overflow port 116 can be connected to a drain pipe. The inlet pipe and drain pipe can be connected to plumbing connections 146 within the housing 105. For the sake of clarity, the inlet pipe and drain pipe are not shown in the cavity below the cooking bays in the illustration of FIG. 3.

Solenoid valves can control the flow of water into and out of the cooking bays. The solenoid valves can be located in the inlet port 113 and drain port 114 or can be located in the inlet pipe and drain pipe proximate to the inlet port and drain port, respectively. The solenoid valves can be controlled by a controller 142. When a cooking bay is to be filled with water, the controller 142 can open the solenoid valve at the inlet port 113. When the inlet solenoid valve is opened, water from a pressurized source, such as a water tank onboard the vehicle, will flow into the cooking bay until the controller 142 closes the inlet solenoid valve. When the cooking bay is to be drained, the controller 142 can open the solenoid valve at the drain port 114. When the drain solenoid valve is opened, water will flow from the cooking bay until the controller 142 closes the drain solenoid valve.

The cooking bay can further comprise a heating element 112, such as an electrical resistive heating element, that heats water within the cooking bay 110. The cooking bay further comprises a temperature sensor 115 that measures the temperature of water within the cooking bay 110. The heating element 112 and temperature sensor 115 are electrically coupled to the controller 142. The controller 142 can provide power and control signals to the heating element 112 thereby controlling when the heating element 112 is turned on or off. The controller 142 can also provide power and can exchange control signals with the temperature sensor 115 in order to monitor the temperature of the water within the cooking bay 110.

In addition to the temperature sensor 115, one or more other sensors can be incorporated into the cooking bay and be in communication with the controller 142. For example, a salinity sensor can measure a salt level in the water within the cooking bay and provide the measurement to the controller 142. If the quantity of salt in the water of the cooking bay is below a desired level, a signal can prompt a chef to add salt to the water. Another sensor that can be incorporated is a water level sensor, which can be implemented as an ultrasonic sensor that detects the height of the water in the cooking bay. If the water level exceeds a desired height, the water level sensor can provide a signal to the controller 142. A third sensor that can be incorporated into the cooking bay is a contact sensor located at the latch attaching the lid 120 to the top panel of the housing 105. As explained previously, first coupler 123 and second coupler 124 can fasten the lid 120 in a closed position. The contact sensor can detect whether the couplers are joined indicating that the lid is closed. As one example, in a situation where the lid is not closed and the vehicle begins to move, the contact sensor can provide a signal to the controller 142 that generates an alert to the driver.

The controller 142 can include a control pad 140 that is a user interface. The control pad 140 can display the temperature as well as other readings from the additional sensors about the cooking bay 110. Also, the control pad can include a power switch for turning the controller on and off. In addition to the control pad 140, the controller can communicate with a chef onboard the vehicle using various indicators, such as indicator lights 141 illustrated in FIGS. 1-3. Each cooking bay can have an associated indicator light 141 that provides signals to the chef. The indicator lights 141 can display different colors to indicate the status of the bay, such as when the cooking bay is warming up, when the cooking bay has reached a desired temperature, and when a food item is ready to be removed from the cooking bay. Indicating the status of the cooking bay assists the chef in managing the status of multiple food items in different cooking bays.

In the example cooking apparatus 100 of FIGS. 1-3, each cooking bay can have a dedicated controller that supplies power to and receives signals from the components of the respective cooking bay. However, it should be understood that in alternate embodiments, the multiple controllers can be simplified into one master controller that supplies power to and receives signals from the components of some or all of the cooking bays in the cooking apparatus 100. As shown in FIG. 3, the cooking apparatus 100 also includes a power supply 144 that provides power to the controllers. The power supply 144 can receive power from an onboard power source such as a battery or generator. The routine wiring connections between the power supply and the controller(s) and between the controller(s) and the components associated with the cooking bays have been omitted from the FIGS. 1-3 for the sake of clarity. As is known to those of skill in this field, the controller can comprise a printed circuit board that includes a processor, non-transitory computer-readable memory (which can include volatile and persistent memory), a communication interface, and a power circuit for receiving power from the power supply and providing power to the components associated with the cooking bays.

It should be understood that in alternate embodiments, the components of the cooking apparatus 100, including the cooking bays and their components, the controllers, and the plumbing connections can be arranged in other configurations and can have other shapes. Furthermore, it should be understood that the foregoing components of the cooking apparatus 100 are only examples and alternate embodiments may omit certain components or have different components.

Referring now to FIG. 4, the cooking apparatus 100 is shown installed in a vehicle along with an onboard computing system 400. The controller 142 of the cooking apparatus 100 can communicate with the computing system 400 via wireless or wired connections. As described in further detail in connection with FIGS. 5-7, the controller 142 of the cooking apparatus 100 can receive commands from the computing system 400 and provide feedback to the computing system 400. The computing system can comprise a processor 410, a memory 415, and a communications interface 420. The computing system 400 can include a display 430 that can present to a chef information related to cooking various food items. The computing system 400 can also include one or more input devices 425 that the chef can use to provide input to the computing system 400. It can be advantageous if the input device 425 does not require manual contact from the chef in order to keep the chef's hands free for food preparation. As one example, the input device 425 can be a foot pedal that receives inputs from the chef as the chef progresses through a set of cooking instructions. As another example, the input device 425 can also be a microphone that receives audible inputs from the chef. In yet other examples where manual contact by the chef is less of a concern, the display 430 can be a touch screen display that receives inputs from the chef.

The memory 415 can store software, algorithms, instructions and data that can be executed by the processor 410. For example, instructions for preparing various food items can be stored in memory 415 for execution by the processor 410. The instructions can include instructions for the chef that are displayed on display 430 or output audibly via a speaker to the chef. The instructions executed by the processor 410 can also include commands sent via the communications interface 420 to the controller 142 of the cooking apparatus 100. Examples of the instructions executed by the processor 410 of the computing system 400 are described in further detail in connection with the example methods of FIGS. 5-7.

The processor 410 can be implemented in a variety forms that are generally known, including but not limited to a central processing unit, a multi-core processor, a system on a chip, a field programmable gate array, and an application-specific integrated circuit. The memory can include both volatile and persistent memory and can store computer-readable instructions for execution by the processor 410 as well as data such as operational data collected from the cooking apparatus 100. In certain example embodiments, in addition to or as an alternative to local memory, computer-readable instructions and data can be stored remotely on a cloud-based server. The communications interface 420 can support long range wireless communication, for example via a cellular network, with a remote command center managing the operation of the vehicle. The computing system 400 can receive commands from the remote command center and can transmit information such as the preparation status of a food item to the remote command center.

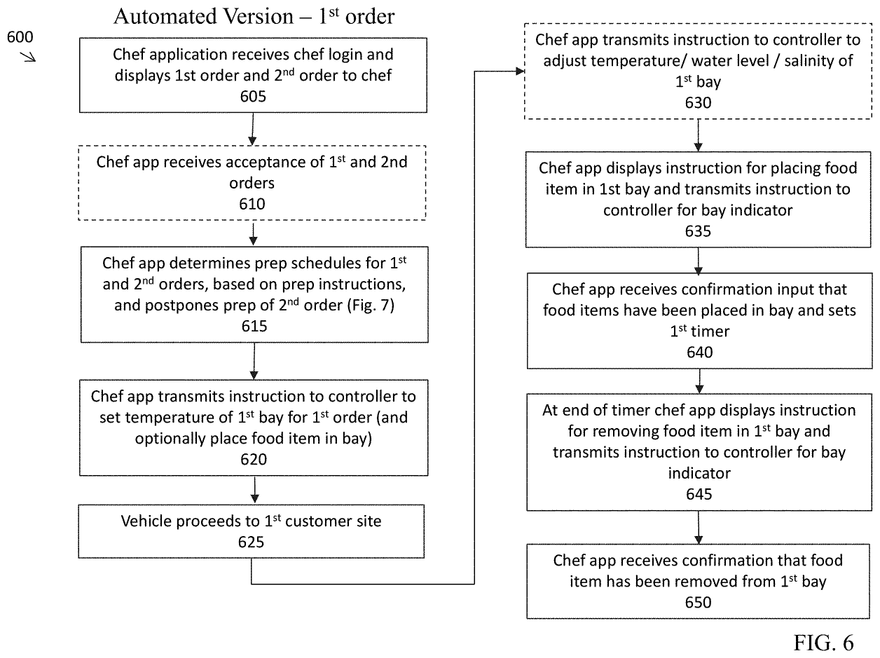

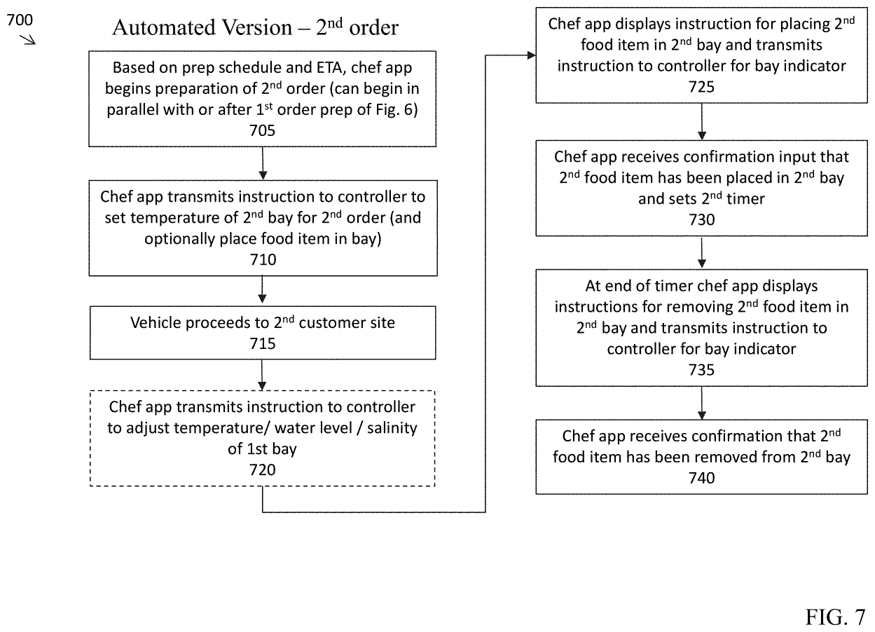

Referring now to FIGS. 5-7, example methods for operation of the computing system 400 and the cooking apparatus 100 are illustrated. The example methods illustrated in FIGS. 5-7 can include algorithms stored as computer-readable instructions in memory 415 for execution by the processor 410. FIG. 5 illustrates an example method 500 for preparation of a food item that includes several manual steps performed by the chef. In contrast, FIGS. 6 and 7 illustrate an alternate method that automates certain steps so that the chef is not required to perform them manually. Additionally, FIGS. 6 and 7 illustrate processes for preparing two food items where the processes can occur in parallel, in series, or in an overlapping manner.

Referring to FIG. 5, example method 500 begins with step 505 wherein computer executable instructions, which can be referred to as a chef application, receiving the chef's login at the computing system 400 and presenting a first order to the chef for preparation. The first order is a food order from a customer and can comprise one or more food items. It should be understood that the login step is optional or may have been completed earlier, in which case the computing system 400 would simply present the first order to the chef for preparation. Step 510 is an optional step whereby the chef application receives an input of the chef's acceptance of the first order. This step is optional because acceptance of the first order may be inferred by the chef beginning with the preparation of the first food item.

Referring to step 515, the chef application analyzes first preparation instructions associated with a first food item. For example, when the computing system 400 receives the first order with the food items from the remote command center, each food item can have associated preparation instructions involving the ingredients needed for preparation, the steps involved in the preparation, and the timing for each of the steps. The timing for each of the preparation instructions can be based on the typical time needed to cook the food item, the average performance of the cooking apparatus, and the heat capacity of the food item. The computing system can collect historical data about the timing for each of the preparation instructions and the actual time for completion in order to improve future cooking processes. For example, the computing system can use historical data to adjust future food preparation instructions for improved accuracy in scheduling.

Referring again to step 515, the chef application's analysis of the preparation instructions can result in a preparation schedule for the food item. The preparation schedule can be based upon the time required to prepare the food item as well as the estimated time that the vehicle will arrive at the customer's location. By determining the preparation schedule, the chef application can ensure the food item is prepared expeditiously. Additionally, a goal of the chef application can be to determine a preparation schedule that times completion of the preparation of the food item close to the estimated time of arrival at the customer's location. Timing completion of the food item preparation close to the estimated time of arrival can ensure that the customer receives a freshly prepared and hot food item.

The chef application's analysis of the preparation instructions for the first food item and determination of a preparation schedule can result in a series of cooking instructions for the first food item. In step 520, the computing system 400 can display a first cooking instruction to set a temperature for a cooking bay of the cooking apparatus 100. Optionally, depending on the preparation schedule, the first cooking instruction can also include an associated instruction to insert the first food item into the cooking bay. In step 525, the computing system 400 can receive a confirmation via input device 425 that the first cooking instruction has been completed so that the computing system can track the progress of the cooking instructions. Upon receiving the confirmation, the vehicle can proceed to the customer's location.

Upon arrival at the customer's location, the chef application may perform optional step 530 which involves one or more of checking and, if needed, adjusting the temperature setting for the cooking bay, the salinity of the water in the cooking bay, and the water level in the cooking bay. For example, depending on the type of food item, placing the food item into the cooking bay may impact the temperature, salinity, or water level of the cooking bay thereby requiring an adjustment. It should be understood that step 530 can occur at various times and multiple times during example method 500. If none of these parameters need to be checked or adjusted, optional step 530 can be omitted from example method 500. Next, in step 535 in response to an indication that the vehicle has arrived at the customer's location, the computing device can display a second cooking instruction to place the first food item into the cooking bay. Placing the first food item in the cooking bay can also coincide with an optional instruction from the computing system 400 to the controller 142 to activate indicator 141. Activating the indicator 141 to signal that the food item is in the process of cooking or warming can assist the chef when multiple food items are in different cooking bays with different preparation schedules. Additional indicators can be included that are triggered by the salinity sensor and the water level sensor. If the first food item was previously placed into the cooking bay in connection with step 520 in order to satisfy the preparation schedule, step 535 can be omitted.

In step 540, after receiving a confirmation that the first food item has been placed in the cooking bay, the computing device can set a first timer associated with the first preparation instructions. For example, the first preparation instructions may indicate that the first food item is to be warmed in a cooking bay at 200 degrees F. for five minutes. In step 545, when the first timer lapses, the chef application can display on display 430 a cooking instruction to remove the first food item from the cooking bay. The instruction to remove the first food item from the cooking bay can be accompanied by a command from the computing system 400 to the controller 142 to change the indicator 141 to signal to the chef the correct cooking bay from which the food item should be retrieved. In step 550, the computing system can receive a confirmation via input device 425 that the first food item has been removed from the cooking bay.

Once the food item has been removed from the cooking bay, the chef can package the first food item, along with any other items of the food order, for delivery to the customer. The computing system 400 can also send a status report to a remote command center monitoring the operations of the vehicle. The status reports can indicate when the preparation is complete and that the food item is ready for delivery to the customer.

Referring now to FIGS. 6 and 7, another example method is illustrated that involves the preparation of two food items using the computing system 400 and the cooking apparatus 100. The method illustrated in FIGS. 6 and 7 is more automated than the previously described method 500 by relying on further communication between the cooking apparatus 100 and the computing system 400. Further automating the cooking instructions and the communications between the cooking apparatus 100 and the onboard computing system 400 facilitates managing multiple preparation schedules for different food items that may occur in series, in parallel, or in a staggered parallel approach. The approach illustrated in FIGS. 6 and 7 can be adapted for preparation of more than two food items and can be particularly helpful for the chef in preparing three or more food items with parallel or overlapping preparation schedules.

In step 605, the chef application executing on the computing system 400 can receive the chef login and can display a first order and a second order. For example, the first order can be for a first customer at a first location and the second order can be for a second customer at a second location. In step 605, the chef login step can be omitted if it was previously performed or if it is unnecessary. In optional step 610, the chef application can receive an acceptance of the first and second orders via an input from the chef.

In step 615, the chef application executing on computing system 400 can analyze the preparation instructions associated with each food item and can determine a first preparation schedule associated with a first food item and a second preparation schedule associated with a second food item. The timing for each of the preparation instructions can be based on the typical time needed to cook the food item, the average performance of the cooking apparatus, and the heat capacity of the food item. The computing system can collect historical data about the timing for each of the preparation instructions and the actual time in which the chef completes the preparation in order to improve future cooking processes. For example, the computing system can use historical data to adjust future food preparation instructions for improved accuracy in scheduling.

Referring again to step 615, the preparation schedules can also be based on an estimated time of arrival at the first customer's location and the second customer's location. For example, the preparation schedules can be set so that they coincide with arrival at the customer's location or conclude within a threshold period of time of the estimated time for arriving at each of the first and second customer's locations. In the example step 615, the chef application can determine that the preparation of the second food item can be delayed based on the length of the second preparation schedule and the estimated time of arrival at the second customer's location.

Proceeding with the first preparation schedule for the first food item, in step 620, the computing system 400 provides a first cooking instruction to the controller 142 of cooking apparatus 100 to set a temperature for a first cooking bay. Depending on the preparation schedule, the computing system 400 may also display an instruction to the chef to place the first food item in the first cooking bay at this time. In step 625, the vehicle proceeds to the first customer's location.

In response to the vehicle arriving at the first customer's location, the computing device can optionally complete the actions associated with step 630. Specifically, sensors of the cooking apparatus 100 can check one or more of the temperature, salinity, and level of the water in the first cooking bay. As explained previously, the type of food item placed into the cooking bay may impact the temperature, salinity, or water level of the cooking bay thereby requiring an adjustment. It should be understood that step 630 can occur at various times and multiple times during example method 600. The sensor readings can be provided by the controller 142 to the computing system 400 and, if needed, the computing system 400 can provide commands to the controller 142 for adjusting the temperature setting, the salinity of the water, and the water level in the first cooking bay. The sensor readings can also trigger one more indicators associated with the second cooking bay. If none of these parameters need to be checked or adjusted, optional step 630 can be omitted from example method 600.

Next, in step 635 in response to an indication that the vehicle has arrived at the customer's location, the computing system 400 can display a second cooking instruction to place the first food item into the first cooking bay. Placing the first food item in the first cooking bay can also coincide with an optional instruction from the computing system 400 to the controller 142 to activate indicator 141. Activating the indicator 141 to signal that the food item is in the process of cooking or warming can assist the chef when multiple food items are in different cooking bays with different preparation schedules. If the first food item was previously placed into the cooking bay in order to satisfy the preparation schedule, step 635 can be omitted.

In step 640, the chef application can receive a confirmation input that the first food item has been placed in the first cooking bay. The confirmation input can occur via an input from the chef at input device 425. Alternatively, the confirmation input can be generated by the controller 142 detecting via a contact sensor that the lid on the first cooking bay has been closed and fastened. In response to receiving the confirmation input, the computing system 400 can set a first timer associated with the first preparation schedule. In step 645, when the first timer lapses, the computing system 400 can display a third cooking instruction to remove the first food item from the first cooking bay. The instruction to remove the first food item from the first cooking bay can be accompanied by a command from the computing system 400 to the controller 142 to change the indicator 141 to signal to the chef that the first cooking bay is the correct cooking bay from which the first food item should be retrieved.

In an alternate embodiment, step 645 can be accompanied by additional commands that the computing system 400 provides to the controller 142. Using the computing system 400 to control operations of the cooking apparatus 100 provides a variety of advantages. For example, when the first timer lapses, the chef may wish to promptly stop the cooking of the food item in the first cooking bay, but the chef may want to leave the first food item in the first cooking bay or the chef may be unable to remove the first food item from the first cooking bay if the chef is occupied with other tasks such as driving. In such situations, the computing system 400 can provide a command to the controller 142 to open the drain valve to drain some or all of the hot water from the first cooking bay in order to slow down or stop the cooking of the first food item. Additionally, the computing system 400 can provide a command to the controller 142 to open the inlet valve to inject cold water into the first cooking bay to further slow down or stop the cooking of the first food item. Controlling the operation of the drain valve and the inlet valve provides another mechanism for controlling the operation of the cooking bay beyond the control of the heating element.

Lastly, in step 650, the computing system 400 can receive a confirmation that the first food item has been removed from the first cooking bay. The confirmation can be in the form of an input from the chef to the computing system 400 or a signal from the contact sensor at the cooking bay lid indicating the lid has been opened and closed thereby suggesting the food item has been removed from the cooking bay. Once the first food item has been removed from the first cooking bay, the chef can package the first food item for delivery to the first customer.

Referring now to FIG. 7, the computing device can begin the second preparation schedule in step 705 so that the second food item will be promptly prepared upon arrival at the second destination or so that its preparation will be completed within a threshold time of arrival at a second destination. The computing system 400 can begin the second preparation schedule at a point during the first preparation schedule described in connection with FIG. 6 so that the two food items are prepared in parallel or overlapping schedules. Alternatively, the computing system 400 can begin the second preparation schedule in series following the first preparation schedule. In step 710, the computing system 400 can provide a fourth cooking instruction to the controller 142 of the cooking apparatus 100 to set a temperature for a second cooking bay. Optionally, if appropriate for the second preparation schedule, the computing system 400 may also display an instruction to the chef to place the second food item in the second cooking bay at this time.

In step 715, the vehicle proceeds to the first customer's location. In response to the vehicle arriving at the first customer's location, the computing device can optionally complete the actions associated with step 720. Specifically, sensors of the cooking apparatus 100 can check one or more of the temperature, salinity, and level of the water in the second cooking bay. As explained previously, the type of food item placed into the cooking bay may impact the temperature, salinity, or water level of the cooking bay thereby requiring an adjustment. It should be understood that step 720 can occur at various times and multiple times during example method 700. The sensor readings can be provided by the controller of the second cooking bay to the computing system 400 and, if needed, the computing system 400 can provide commands to the second cooking bay controller for adjusting the temperature setting, the salinity of the water, and the water level in the second cooking bay. The sensor readings can also trigger one more indicators associated with the second cooking bay. If none of these parameters need to be checked or adjusted, optional step 720 can be omitted from example method 700.

Next, in step 725, in response to an indication that the vehicle has arrived at the customer's location, the computing system 400 can display a fifth cooking instruction to place the second food item into the second cooking bay. Placing the second food item in the second cooking bay can also coincide with an optional instruction from the computing system 400 to the second cooking bay controller to activate indicator 141. Activating the indicator 141 to signal that the second food item is in the process of cooking or warming can assist the chef when multiple food items are in different cooking bays with different preparation schedules. If the second food item was previously placed into the second cooking bay in order to satisfy the second preparation schedule, step 725 can be omitted.

In step 730, the chef application can receive a confirmation input that the second food item has been placed in the second cooking bay. The confirmation input can occur via an input from the chef at input device 425 or via a sensor reading communicated from the cooking apparatus 100 by the controller. In response to receiving the confirmation input, the computing system 400 can set a second timer associated with the second preparation schedule. In step 735, when the second timer lapses, the computing system 400 can display a sixth cooking instruction to remove the second food item from the second cooking bay. The instruction to remove the second food item from the second cooking bay can be accompanied by a command from the computing system 400 to the controller to change the indicator 141 to signal to the chef that the second cooking bay is the correct cooking bay from which the second food item should be retrieved. In step 740, the computing system can receive a confirmation that the second food item has been removed from the second cooking bay and that the second food item is ready for packaging and delivery to the second customer.

In the foregoing example, the first preparation schedule can be based on a first estimated arrival time at the first destination and the second preparation schedule can be based on a second estimated arrival time at the second destination. The estimated arrival times can be adjusted based on traffic patterns, changes in customer orders, or other factors and the computing system 400 can accordingly adjust the preparation schedules based on adjustments of the estimated arrival times. Additionally, at the end of method 600 and method 700, the computing system 400 can collect data reflecting the actual time required to prepare the first food item and second food item for comparison to the preparation schedules set near the beginning of each method. Collecting the actual time required to prepare the food items and performing the comparison to the preparation schedules for many food items over time provides historical data that the computing system 400, or a remote computing system, can used to adjust preparation schedules in the future and to improve the food item preparation methods.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Similarly, for any apparatus shown and described herein, one or more of the components may be omitted, added, repeated, and/or substituted. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Referring generally to the examples herein, any components of the apparatus (e.g., the cooking apparatus housing, the cooking bay and its associated components), described herein can be made from a single piece (e.g., as from a mold, injection mold, die cast, 3-D printing process, extrusion process, stamping process, or other prototype methods). In addition, or in the alternative, a component of the apparatus can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to couplings that are fixed, hinged, removeable, slidable, and threaded.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although example embodiments are described herein, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A cooking apparatus comprising:
a housing comprising a top panel and at least one side wall;
a controller comprising a control pad, the control pad located on an exterior of the housing;
a cooking bay attached to the top panel of the housing and defining a cavity, the cooking bay comprising:
a heating element,
a sensor,
an inlet port,
a drain port, and
a lid operable to cover the cavity;
an inlet pipe comprising an inlet valve, the inlet pipe coupled to the inlet port; and
a drain pipe comprising a drain valve, the drain pipe coupled to the drain port,
wherein the cooking apparatus is configured for installation in a vehicle.

2. The cooking apparatus of claim 1, further comprising:
a gasket that creates a seal between the lid and a mouth of the cavity; and
a latch that secures the lid to the top panel.

3. The cooking apparatus of claim 1, further comprising an indicator adjacent to the cooking bay, the indicator identifying one of a plurality of states of the cooking bay, the plurality of states comprising: a not ready state and a ready state.

4. The cooking apparatus of claim 1, wherein the inlet pipe is coupled to a pressurized water tank and wherein the cooking apparatus and the pressurized water tank are located in the vehicle.

5. The cooking apparatus of claim 1, wherein the cooking apparatus is disposed in the vehicle and the controller is operable to communicate with a computing device disposed in the vehicle, the computing device comprising a processor and instructions executable by the processor.

6. The cooking apparatus of claim 5, wherein the computing device, in accordance with the instructions, is operable to determine a first preparation schedule for a first food item and a second preparation schedule for a second food item, wherein the first preparation schedule comprises a first plurality of cooking instructions and wherein the second preparation schedule comprises a second plurality of cooking instructions.

7. The cooking apparatus of claim 6, wherein the first preparation schedule sets preparation of the first food item to be completed within a first threshold time of arriving at a first destination and the second preparation schedule sets preparation of the second food item to be completed within a second threshold time of arriving at a second destination.

8. The cooking apparatus of claim 6, wherein the computing device,
in accordance with the first plurality of cooking instructions, directs the controller to heat the water in the cooking bay to a first temperature; and
in accordance with the second plurality of cooking instructions, directs the controller to heat the water in the cooking bay to a second temperature.

9. The cooking apparatus of claim 5, further comprising an input device to the computing device, wherein the input device comprises one of a foot pedal and a microphone.

10. The cooking apparatus of claim 5, wherein the computing device directs the controller to open the drain valve to remove heated water from the cooking bay and to open the inlet valve to inject cool water into the cooking bay.

11. The cooking apparatus of claim 6, further comprising one of:
a salinity sensor that measures a salinity of the water in the cooking bay; and
a contact sensor that detects when the lid is fastened over the cavity.

12. A method for operating a cooking apparatus onboard a vehicle, the method comprising:
analyzing, by a computing device, first preparation instructions associated with a first food item;
displaying, by the computing device, a first cooking instruction to set a temperature for a cooking bay;
receiving, by the computing device, a confirmation that the first cooking instruction has been completed;
displaying, by the computing device in response to receiving an indication that the vehicle has arrived at a destination, a second cooking instruction to place the first food item into the cooking bay;
receiving, by the computing device, a confirmation that the first food item has been placed into the cooking bay and, in response thereto, setting a first timer associated with the first preparation instructions;
displaying, by the computing device in response to the first timer lapsing, a third cooking instruction to remove the first food item from the cooking bay; and
receiving, by the computing device, a confirmation that the first food item has been removed from the cooking bay.

13. The method of claim 12, wherein the computing device receives confirmations via one of a foot pedal input device and a microphone.

14. The method of claim 12, further comprising:
transmitting, by the computing device in response to receiving the confirmation that the first food item has been placed into the cooking bay, a command to a controller associated with the cooking apparatus, the command initiating the controller to turn on an indicator light associated with the cooking bay.

15. The method of claim 12, further comprising:
transmitting, by the computing device to a remote command center, a status report associated with the first food item.

16. A method for operating a cooking apparatus onboard a vehicle, the method comprising:
determining, by a computing device, a first preparation schedule associated with a first food item and a second preparation schedule associated with a second food item;
providing, by the computing device, to the cooking apparatus a first cooking instruction to set a temperature for the first cooking bay in accordance with the first preparation schedule;
displaying, by the computing device in response to the vehicle arriving at a first destination, a second cooking instruction to place the first food item into the first cooking bay in accordance with the first preparation schedule;
setting, by the computing device, a first timer associated with the first preparation schedule; and
displaying, by the computing device in response to the first timer lapsing, a third cooking instruction to remove the first food item from the first cooking bay.

17. The method of claim 16, further comprising:
providing, by the computing device, to the cooking apparatus a fourth cooking instruction to set a temperature for a second cooking bay in accordance with the second preparation schedule;
displaying, by the computing device in response to the vehicle arriving at a second destination, a fifth cooking instruction to place the second food item into the second cooking bay in accordance with the second preparation schedule;
setting, by the computing device, a second timer associated with the second preparation schedule; and
displaying, by the computing device in response to the second timer lapsing, a sixth cooking instruction to remove the second food item from the second cooking bay.

18. The method of claim 17, wherein
the first preparation schedule is based on a first estimated arrival time at the first destination, an average performance of the cooking apparatus, and a heat capacity of the first food item; and
the second preparation schedule is based on a second estimated arrival time at the second destination, an average performance of the cooking apparatus, and a heat capacity of the second food item.

19. The method of claim 17, wherein the computing device is further operable to:
adjust the first preparation schedule based on an estimated arrival time for the first destination; and
adjust the second preparation schedule based on an estimated arrival time for the second destination.

20. The method of claim 16, further comprising providing, by the computing device to the cooking apparatus in response to receiving a sensor signal from the cooking apparatus, a command to adjust one or more of:
a salinity of water in the first cooking bay;
a level of the water in the first cooking bay; and
the temperature of the water in the first cooking bay.
